(19) United States
(12) Patent Application Publication
(10) Pub. No.: US 2013/0317718 A1
(43) Pub. Date: Nov. 28, 2013

(54) VEHICLE CONTROL SYSTEM AND MANUFACTURING METHOD THEREFOR

(71) Applicant: Hirofumi Sato, Mishima-shi (JP)

(72) Inventor: Hirofumi Sato, Mishima-shi (JP)

(21) Appl. No.: 13/984,337

(22) PCT Filed: Feb. 16, 2011
(86) PCT No.: PCT/JP2011/053251

§ 371 Date: Aug. 8, 2013

(51) Int. Cl. G06F 17/00

(52) U.S. Cl. CPC G06F 17/00
USPC 701/70; 701/1

(57) ABSTRACT

A vehicle control system configured to change a control amount exponentially with respect to an operating amount of the driver in a manner to reduce a gap between an intended feeling of the driver and an actual feeling resulting from the operation, irrespective of changes in circumstances surrounding the vehicle.

The vehicle control system is configured to calculate a control amount in accordance with an operating amount of the driver to control the vehicle based on the calculated control amount. The vehicle control system is provided with a calculation means that calculates the control amount by exponentiating the operating amount in a manner to increase a climb gradient of the control amount in accordance with an increase in the operating amount in a first range where the operating amount is small, and to decrease the climb gradient of the control amount in accordance with an increase in the operating amount in a second range where the operating amount is large. The calculation means is configured to exponentiate the control amount using a power index, which is determined in a manner to keep a difference between the calculated control amount and a control amount determined for a reference vehicle whose maximum control amount is different within a predetermined range, from a minimum operating amount to a maximum operating amount.

### TECHNICAL FIELD

This invention relates to a system for controlling a vehicle based on an operation of a driver and a manufacturing method therefore.

### BACKGROUND ART

A vehicle is propelled, turned and stopped manually by steering and accelerating/decelerating operations of a driver, and driving behavior of the vehicle resulting from such operations is changed depending on the characteristics of an operation system. Specifically, sporty driving behavior is provided by tuning the characteristics of the operation system in a manner to change the behavior of the vehicle relatively greatly with respect to an operating amount. To the contrary, mild driving behavior of the vehicle is provided by tuning the characteristics of the operation system in a manner to change the behavior of the vehicle relatively small or slowly with respect to an operating amount. In this case, fuel economy of the vehicle is improved.

For example, a stimulus arising from an acceleration or a driving force resulting from an operation of an accelerator, and a stimulus arising from a yaw rate resulting from an operation of a steering wheel may be determined in a quantitative fashion per Weber-Fechner law. Therefore, Japanese Patent Laid-Open No. 2009-41544 discloses a system adapted to change a target driving force exponentially with respect to a change in an operating amount of the driven According to the teachings of Japanese Patent Laid-Open No. 2009-41544, a vehicle behavior may be changed in response to e.g., an accelerating operation and decelerating operation of the driver without providing uncomfortable feeling to the driver. In addition, Japanese Patent Laid-Open No. 2009-83542 discloses a control device adapted to change a coefficient of an exponential function determining a relation between an operating amount such as an opening degree of an accelerator and a stimulus such as an acceleration demand, depending on a running condition or environment of the vehicle.

Characteristics of the driving force differ according to type and grade of vehicle, and a tendency of drive demand differ according to the driver. Therefore, Japanese Patent Laid-Open No. 2009449161 discloses an output device that allows a driver to select a driving mode from a plurality of driving modes by an operation of a switch.

According to the teachings of Japanese Patent Laid-Open No. 200941544, for example, the driving force is increased exponentially according to an increase in an opening degree of the accelerator. However, the maximum driving force of the vehicle has to be limited by a structure of a power train formed by an engine, a transmission and so on. Therefore, when the accelerator pedal is depressed deeply, the driving force or the acceleration is once increased to the maximum value but then drops abruptly to produce uncomfortable feeling.

Meanwhile, according to the teachings of Japanese Patent Laid-Open No. 2009-83542, the coefficient of an exponential function determining a target driving force or a target acceleration is changed depending on a running condition or environment of the vehicle. Therefore, for example, the uncomfortable feeling produced as a result of depressing the accelerator pedal deeply may be reduced. However, the maximum driving force and the maximum depth (i.e., the maximum stroke) of the accelerator pedal differs depending on type and grade of vehicle. That is, the above-mentioned coefficient has to be determined for each type and grade of vehicle. In the conventional art, a preferable value of such coefficient is determined on the basis of data obtained from a driving test. Therefore, a number of people and a considerable time are required to design and manufacture vehicles of those kinds. In addition, in order to design and manufacture a vehicle having a plurality of drive modes as taught by Japanese Patent Laid-Open No. 2009-149161, such coefficient or formulas determining an operating amount and a control amount has to be determined for each driving mode by carrying out a driving test under each driving mode. Therefore, more people and longer time may be required to design and manufacture vehicles of this kind.

### DISCLOSURE OF THE INVENTION

In order to solve the foregoing technical problems, it is an object of this invention to provide a vehicle control system and a manufacturing method therefore, which allows to easily determine a control amount with respect to an operating amount or control characteristics as a variation of the control amount, and to easily determine a unified or standardized control characteristics for any types and grades of vehicles.

The vehicle control system is configured to calculate a control amount with respect to an operating amount of a driver, and to control a vehicle based on the calculated control amount. In order to achieve the foregoing objective, the vehicle control system is provided with a calculation means that calculates the control amount by exponentiating the operating amount in a manner to increase a climb gradient of the control amount in accordance with an increase in the operating amount in a first range where the operating amount is small, and to decrease the climb gradient of the control amount in accordance with an increase in the operating amount in a second range where the operating amount is large. According to the present invention, the calculation means is configured to exponentiate the control amount using a power index, which is determined in a manner to keep a difference between the calculated control amount and a control amount determined for a reference vehicle whose maximum control amount is different within a predetermined range, from a minimum operating amount to a maximum operating amount.

Specifically, the power index is determined based on a maximum operating amount with respect to a vehicle speed.

According to the present invention, the calculation means is configured to calculate the control amount by multiplying the exponentiated operating amount by a coefficient determined based on the maximum operating amount and a maximum control amount.

The vehicle is provided with a mode selector means configured to select a driving mode from a plurality of driving modes, and the power index is determined for each driving mode.

The vehicle is further provided with an operating amount adjusting means that alters a maximum structural operating amount in accordance with the power index for the driving mode selected by the mode selector means.

The vehicle is further provided with a prime mover, and an output of the prime mover is changed by operating an accelerator. According to the present invention, the operating amount includes an accelerator stroke, and the control amount includes a target acceleration or a target driving force.

More specifically, the calculation means is configured to calculate the target acceleration or the target driving force using the flowing formulas:

Gx=c·Ps^{k}Gx0 and

c=(Gxmax−Gx0)/Psmax^{k}

where Gx is the target acceleration or the target driving force, c is the coefficient, Ps is an opening degree of the accelerator, Psmax is the maximum opening degree of the accelerator, Gx0 is a minimum acceleration or a minimum driving force of the vehicle, Gxmax is a maximum acceleration or a maximum driving force of the vehicle, and k is the power index.

According to another aspect of the present invention, there is provided a manufacturing method of a vehicle control system for calculating a target acceleration or a target driving force to control a vehicle in a manner to achieve the calculated target acceleration or target driving force. The manufacturing method of the present invention is comprised of: determining a coefficient c and a power index k in the following formulas for a given reference vehicle; determining the coefficient c and the power index k for another vehicle Whose maximum acceleration or maximum driving force is different from that of the reference vehicle, in a manner to approximate a relation between the target acceleration or the target driving force of said another vehicle and the opening degree of the accelerator, within a predetermined range around a relation between the target acceleration or the target driving force of the reference vehicle and the opening degree of the accelerator; and thereafter calculating the target acceleration or the target driving force for said another vehicle by assigning the determined coefficient c and the power index k into the following formulas:

Gx=c·Ps^{k}+Gx0 and

c=(Gxmax−Gx0)/Psmax^{k}

where Gx is the target acceleration or the target driving force, c is the coefficient, Ps is an opening degree of the accelerator, Psmax is the maximum opening degree of the accelerator, Gx0 is a minimum acceleration or a minimum driving force of the vehicle, Gxmax is a maximum acceleration or a maximum driving force of the vehicle, and k is the power index.

Thus, according to the present invention, the control amount such as the target acceleration, the target driving force, or a target yaw rate is calculated by exponentiating the operating amount such as the opening degree of the accelerator or a steering angle. Specifically, such control amount is determined in a manner to increase a climb gradient of the control amount in a first range where the operating amount is relatively small, and to decrease the climb gradient of the control amount in a second range where the operating amount is relatively large. According to the present invention, therefore, the climb gradient of the control amount is reduced gradually as an increase in the operating amount in the vicinity of the maximum value. For this reason, the driver will not feel uncomfortable feeling caused by an abrupt reduction in the control amount when the operating amount is large. In addition, according to the present invention, the power index used in the formulas for calculating the control amount is determined in a manner to approximate the calculated control amount to the control amount of the reference vehicle. Therefore, control characteristic similar to that of the reference vehicle can be determined by merely correcting or modifying the power index based on the maximum operating amount or the maximum control amount. In other words, preferable control characteristics of vehicle can be determined by a numerical process without spending time carrying out a driving test for collecting data.

As described, the vehicle is provided with a mode selector means configured to select a driving mode from a plurality of driving modes, and the power index is determined for each driving mode. According to the present invention, therefore, the control characteristics can be adjusted in accordance with the selected mode.

In addition, according to the present invention, a driving force curve as a relation between the target acceleration or the target driving force and the opening degree of the accelerator can be determined based on the maximum acceleration or the maximum driving force in a manner to be approximated to that of the reference vehicle. Therefore, the control characteristics or the driving force curve may be determined easily. In addition, according to another aspect of the present invention, the vehicle control system for determining the control characteristics or the driving force curve can be manufactured easily.

### BRIEF DESCRIPTION OF THE DRAWINGS

FIG. 1 is a graph indicating characteristic curves of calculation value of acceleration demand according to the control system of the present invention.

FIG. 2 is a graph indicating characteristic curves of calculation value of acceleration demand for each driving mode.

FIG. 3 is a block diagram illustrating a control line for altering an accelerator stroke in accordance with the selected driving mode.

FIG. 4 is a view schematically illustrating a structure of the vehicle to which the present invention is applied.

FIG. 5 is a block diagram illustrating a control line for controlling the drive torque of the vehicle shown in FIG. 4.

### BEST MODE FOR CARRYING OUT THE INVENTION

The present invention relates to a control system for a vehicle, which is propelled, turned and stopped by an operation of a driver, and in which components thereof are also manipulated by an operation of the driver. The control system of this kind is configured to replace an actual operating amount with control data, and create control command data by calculating based on the control data. Therefore, the control system of this kind carries out an actual control while replacing the created control command data with an actual control amount. The control amount thus obtained may vary depending on the way of calculation or replacement process, and a value of coefficient or gain. Thus, the replacement process, the coefficient, and the gain will affect the control characteristics.

The control amount thus obtained governs an acceleration, a deceleration, a tuning performance etc. of the vehicle, and the actual vehicle behavior is sensed by the driver. Therefore, it is preferable to adjust the control characteristics in a manner to actualize a vehicle behavior intended by passengers (especially by the driver). For example, when the accelerator pedal is depressed, the control system determines that the driver demands for acceleration, and increases a drive torque to satisfy the driver's acceleration demand. Acceleration characteristic of vehicle is governed by a relation between a depression of the accelerator and a target acceleration or an actual acceleration. For example, a so-called sporty drive feeling is provided by tuning the acceleration characteristics in a manner to generate a large torque at a small opening degree. To the contrary, driving comfort is enhanced by tuning the acceleration characteristics in a manner to increase the torque gently with respect to a depression of the accelerator pedal. Such vehicle characteristics are determined for each type and grade of vehicle at a design phase. That is, a depression depth of the accelerator and a maximum output (i.e., a maximum driving force) of the vehicle differ according to type and grade of the vehicle. Therefore, a relation between a driving force (or a driving torque) to be outputted and an opening degree of the accelerator is determined for each type and grade of the vehicle.

As described, the control system of the present invention is adapted to determine the control characteristics of the vehicle uniformly irrespective of type and grade of the vehicle by simply carrying out a calculation. The control system of the present invention may be applied to conventional vehicles adapted to be accelerated or decelerated by operating an accelerator, For example, in the vehicle shown in FIG. 4 to which the control system of the present invention is applied, a transmission (T/M) 2 is connected to a prime mover 1, and torque outputted from the transmission 2 is transmitted to both wheels 4 through a final reduction gear unit 3. Any of an internal combustion engine such as a gasoline engine and a diesel engine, a motor, and a hybrid drive unit (HV) formed by combining the engine and the motor may be employed as the prime mover 1.

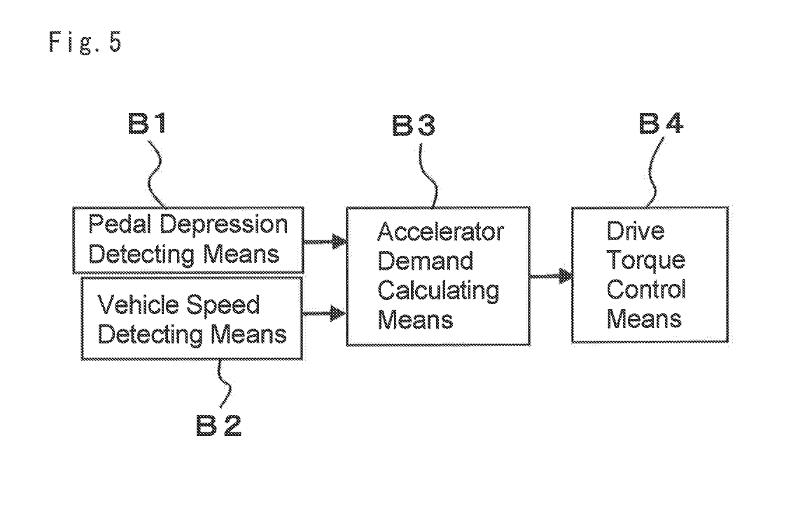

An accelerator pedal 5 is adapted to accelerate and decelerate the vehicle, A depression of the accelerator 5, that is, an opening degree of the accelerator is detected by a not shown sensor, and the detected value of the opening degree is sent to an electronic control unit (ECU) 6. The electronic control unit 6 is composed mainly of a microcomputer, and configured to output a command signal while carrying out a calculation based on data inputted thereto and data and program stored in advance. For example, the electronic control unit 6 calculates an acceleration demand (i.e., a target acceleration) based on a drive demand represented by an opening degree and a vehicle speed, and calculates a drive torque (i.e., a target driving force) required to satisfy the calculated acceleration demand. FIG. 5 is a block diagram illustrating the control system. In FIG. 5, a pedal depression detecting means B1 is configured to detect a depression of the accelerator pedal 5 or a drive demand, and a vehicle speed detecting means B2 is configured to detect a vehicle speed. Detection signals of the detecting means B1 and B2 are sent to an acceleration demand calculating means B3.

The acceleration demand may be calculated by a conventional procedure. For example, the acceleration demand calculating means B3 obtains a drive demand with reference to a map determining the drive demand based on a vehicle speed and an opening degree of the accelerator; and calculates the acceleration demand based on the drive demand thus obtained and a vehicle mass, Then, a drive torque control means B4 controls a drive torque in accordance with the acceleration demand thus calculated. Specifically, the drive torque control means B4 calculates the drive torque by the conventional calculation based on an output torque of the prime mover 1, a speed ratio of the transmission 2, a gear ratio of the final reduction gear unit 3, a wheel diameter and so on, and sends a control signal to the prime mover 1 and the transmission 2 to achieve the drive torque thus calculated.

The vehicle control system of the present invention is provided with a calculation means configured to carry out the above-explained calculation for calculating the acceleration demand using formulas prepared in a manner to optimize the acceleration feeling. In a vehicle, the acceleration feeling of the driver may be optimized by harmonizing the actual acceleration resulting from operating the acceleration pedal with an intended or imagined acceleration of the driver. A stimulus arising from an accelerating operation may be determined in a quantitative fashion using Weber-Fechner law. For example, provided that an opening degree of the accelerator is the operation, and acceleration is the stimulus, comfortable acceleration may be generalized by exponentiating the opening degree of the accelerator. Specifically, as taught by Japanese Patent Laid-Open No, 2009-86542, the acceleration “α” can be expressed as:

α=c·A^{k}

where “c” is a coefficient according to a vehicle speed, “A” is the opening degree of the accelerator, and “k” is a power index. That is, in the above expression, the power index “k” is a function of the opening degree “A” of the accelerator. Specifically, when the opening degree “A” of the accelerator is small, the power index “k” is larger than “1”. However, the power index “k” is decreased gradually in accordance with an increase in the opening degree “A” of the accelerator, and becomes smaller than “1” when the opening degree “A” of the accelerator becomes almost maximum degree. Thus, the power index “k” is determined in accordance with the vehicle speed:

The opening degree “A” of the accelerator may be substituted by an accelerator stroke “Ps”, and the acceleration “α” may be substituted by an acceleration demand “Gx”. Therefore, the above expression may be reformed as follows:

Gx=c·Ps^{k}+Gx0.

The coefficient “c” in the above expression may be determined using the following formula:

c=(Gxmax−Gx0)/Psmax^{k}.

In the above formulas, “Gx0” is a minimum acceleration generated when the vehicle is idling, that is, the acceleration generated by a creep torque, and “Gxmax” is a maximum acceleration generated at a maximum accelerator stroke “Psmax”.

In this case, the power index “k” is decreased in accordance with an increase in the accelerator stroke “Ps” toward the maximum accelerator stroke “Psmax”, that is, the power index “k” is decreased in accordance with an increase in the calculated acceleration demand “Gx” toward the maximum acceleration Gxmax“: That is, the acceleration demand “Gx” or the drive demand (as will be simply called the acceleration demand Gx” hereinafter) thus calculated with respect to the accelerator stroke “Ps” may be increased and decreased depending on setting of the power index “k”. Therefore, calculated value of the acceleration demand with respect to the accelerator stroke may be adjusted to meet a preference of the driver by optimizing the power index “k”. However, preference of the actual acceleration with respect to the accelerator stroke varies from person to person. Therefore, in order to determine the above-explained power index “k”, an in-vehicle research is carried out by different drivers to find out the acceleration where the drivers find it pleasurable with respect to the accelerator stroke. Then, the power index “k” is determined in accordance with the vehicle speed and in a manner to achieve the acceleration frequently demanded by the drivers.

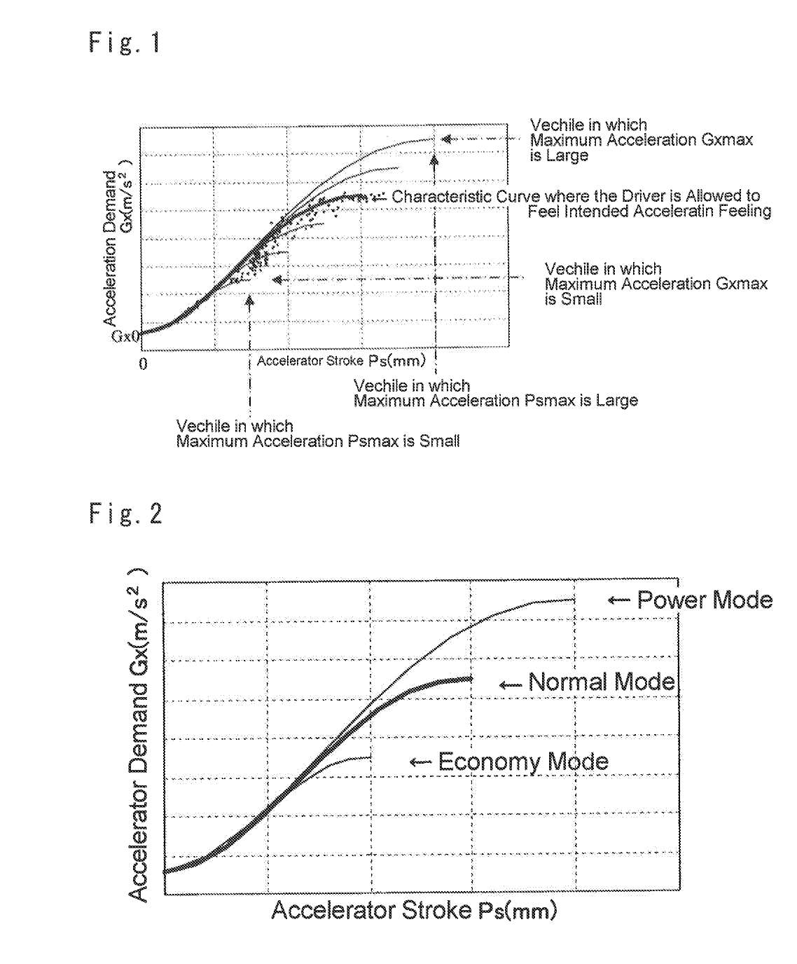

Referring now to FIG. 1, data about the actual acceleration with respect to the accelerator stroke Ps collected from a driving test using a selected reference vehicle is plotted in FIG. 1. As can be seen from FIG. 1, tendency of change in the collected actual acceleration is generally conform to tendency Of change in the acceleration demand “Gx” calculated using the above formula. Therefore, according to the present invention, the above-explained power index “k” is determined in a manner to approximate the calculated value of the acceleration demand “Gx” within a predetermined range around the average value of the collected acceleration. For this purpose, the coefficient “c” in the above expression is determined based on designed values of the maximum acceleration “Gxmax” and the minimum acceleration “Gx0” of the reference vehicle, and the power index “k” thus determined. In FIG. 1, the thick curved line is a characteristic curve indicating the acceleration demand “Gx” of the reference vehicle thus calculated. In order to determine the acceleration demand with respect to the accelerator stroke, the characteristic curve of the calculation value of the acceleration demand thus determined for the reference vehicle, or the formulas for calculating the acceleration demand thus determined for the reference vehicle is/are stored in the control system for vehicles in which a power train including the prime mover and the operation devices such as the accelerator pedal are structurally similar to those of the reference vehicle.

The characteristic curve of the calculation value of the acceleration demand thus determined for the reference vehicle may be modified for other types or grades of vehicles. To this end, specifically, the maximum accelerator stroke “Psmax” of the other type of vehicle, and the maximum acceleration “Gxmax” of the other type of vehicle achieved at the maximum accelerator stroke “Psmax” are substituted into the above formulas for calculating the acceleration demand “Gx”, That is, the characteristic curve of the calculation value of the acceleration demand is determined for each type and grade of vehicle based on the maximum accelerator stroke “Psmax” and the maximum acceleration “Gxmax”. In FIG. 1, the characteristic curves of calculation value of the acceleration demand for the other types of vehicles thus determined based on the characteristic curve of the reference vehicle are indicated by the fine curved lines.

In addition, size of a passenger cabin, structure (i.e., softness) of a seat, loudness of an engine noise in the cabin etc. may differ depending on the type or grade of vehicles. For this reason, the acceleration feeling of the driver may vary even under the same acceleration. However, the characteristic curves of calculation value of the acceleration demand for the other types of vehicles thus determined based on that for the reference vehicle shown in FIG. 1 may be adjusted by a numerical process to eliminate a gap in the acceleration feeling resulting from the above-explained structural difference. For this purpose, specifically, the formula for calculating the acceleration demand “Gx” for the reference vehicle is modified taking into consideration the structural difference between the reference vehicle and the vehicle to be tuned. Then, an in-vehicle research is carried out using the characteristic curve of calculation value of the acceleration demand obtained by the formula for calculating the acceleration demand “Gx” thus modified for the vehicle to be tuned, and the power index “k” and the coefficient “c” are adjusted based on the result of the research. As a result, the characteristic curve of calculation value of the acceleration demand for the vehicle to be tuned is approximated within a predetermined range around that for the reference vehicle. That is, a difference between the characteristic curves of calculation value of the acceleration demand for the vehicle to be tuned and for the reference vehicle falls within the predetermined range. A man-hour required for tuning the characteristic curve of calculation value of the acceleration demand by the forgoing procedure is much shorter and simpler than that required for determining the characteristic curve of calculation value of the acceleration demand from the beginning.

The characteristic curves of calculation value of the acceleration demand shown in FIG. 1 will be explained in more detail. In the first range of the accelerator stroke “Ps” from “0” to a slightly larger value, the power index “k” is relatively large, that is, larger than “1”. Meanwhile, the power index “k” is reduced gradually in the second range where the accelerator stroke “Ps” is larger than that in the first range, and the power index “k” is kept approximately to “1” in the range between the first range and the second range. Therefore, in the first range where the accelerator stroke “Ps” is relatively small, all of the characteristic curves of calculation value of the acceleration demand “Gx” for vehicles differ in the maximum acceleration “Gxmax” overlap one another. As described, the power index “k” is approximately “1” in the range between the first range and the second range. Then, a gradient of each characteristic curve of calculation value of the acceleration demand “Gx” is reduced gradually with an increase in the accelerator stroke “Ps”, and the climb gradient of each characteristic curve becomes extremely small at the maximum acceleration “Gxmax”, that is, an increase in the calculation value of the acceleration demand “Gx” stops just before the maximum acceleration “Gxmax”.

The climb gradient of the characteristic curve of calculation value of the acceleration demand “Gx” for the vehicle whose maximum acceleration “Gxmax” is larger starts decreasing at a larger value of the accelerator stroke “Ps”. That is, the calculation value of the acceleration demand “Gx” with respect to the accelerator stroke “Ps” differs depending on the maximum acceleration “Gxmax” of the vehicle or the control system in the range where the accelerator stroke “Ps” is large. This means that the range of the accelerator stroke “Ps” where the characteristic curves overlap one another may be used as the common use range of the accelerator stroke “Ps”. Consequently, the calculation value of the acceleration demand “Gx” with respect to the accelerator stroke “Ps” in this range may be standardized for any types or grades of vehicles. In other words, according to the vehicle control system and the manufacturing method of the present invention, the characteristic curve of the acceleration may be approximately-determined for different types or grades of vehicles. Therefore, the driver is allowed to feel substantially consistent and intended acceleration feeling as a physical stimulus with respect to a predetermined depression of the accelerator pedal 5, even if the driver changes the vehicle in which the characteristic curve of calculation value of the acceleration demand is thus determined. In addition, the characteristic curve of calculation value of the acceleration demand for the reference vehicle may be tuned easily to meet the driver's preference by a numerical process.

Just for reference, the acceleration demand may also be calculated based on a ratio of an actual accelerator stroke to the maximum accelerator stroke “Psmax”. In this case, the acceleration demand may be calculated easily on a pro-rata basis. However, if the acceleration demand is calculated by this procedure, an actual acceleration with respect to the depression of the accelerator may deviate from the driver's intension or senses, that is, the driver may feel a gap between the intended acceleration feeling and an actual acceleration feeling. Moreover, the acceleration with respect to a predetermined depression of the accelerator may vary depending on the type or grade of vehicles. Alternatively, the acceleration demand may also be calculated using a power index obtained by dividing the maximum stroke or opening degree of accelerator by a current stroke or opening degree of accelerator. In this case, the calculated acceleration demand is increased proportionally to the maximum acceleration with respect to an increase in the accelerator stroke. That is, the calculation value of the acceleration demand is increased monotonically and restricted suddenly at the upper limit value of the acceleration. Therefore, the driver may feel uncomfortable feeling.

Thus, according to the present invention, the characteristic curve of calculation value of the acceleration demand is determined by adjusting or modifying the characteristic curve or the formulas for calculating the acceleration demand already determined for the reference vehicle, based on the maximum accelerator stroke “Psmax” and the maximum acceleration “Gxmax” of the vehicle to be tuned. Therefore, according to the present invention, a required man-hour for manufacturing the vehicle control system can be reduced. As described, specifically the characteristic curve of calculation value of the acceleration demand is determined by exponentiating the accelerator stroke by the power index as a function of the accelerator stroke. Therefore, an intended acceleration with respect to a depression of the accelerator can be achieved so that the driver is allowed to feel driving pleasure. In addition, the characteristic curve of calculation value of the acceleration demand can be standardized easily for different types or grades of vehicles in which the maximum accelerator stroke “Psmax” and the maximum acceleration “Gxmax” are different. As also described, according to the manufacturing method of the present invention, the characteristic curve of calculation value of the acceleration demand or formulas for calculating the acceleration demand determined for the reference vehicle is adjusted or modified to determine the characteristic curve of calculation value of the acceleration demand for another vehicle to be tuned, based on the maximum accelerator stroke “Psmax” and the maximum acceleration “Gxmax” of the vehicle to be tuned. Therefore, the characteristic curve of calculation value of the acceleration demand to be stored in the control system for another vehicle can be determined easily.

As can be seen from FIG. 1, in the range where the accelerator stroke is large (i.e., in the aforementioned second range), the calculation value of the acceleration demand of the vehicle whose maximum acceleration is large is larger than that of the vehicle whose maximum acceleration is small, with respect to a predetermined accelerator stroke. Such variation characters are governed by characteristics of the above-explained formulas. Therefore, it is possible to easily diversify functions and driving performance of the vehicle utilizing those formulas. For example, a plurality of driving mode can be set to differentiate a calculation value of acceleration demand (or an actual acceleration to be achieved) in the range where the accelerator stroke is large.

FIG. 2 indicates characteristic curves of calculation value of the acceleration demand for power mode, normal mode and economy mode, As can be seen from FIG. 2, the maximum accelerator stroke “Psmax” and the maximum acceleration “Gxmax” are differentiated in those modes, Those driving modes are selected in a single vehicle, and under the power mode, the accelerator is allowed to be depressed to a maximum structural depth to achieve the maximum acceleration (or driving force). Meanwhile, under the normal mode, the accelerator stroke is restricted to nearly half depth to limit the maximum acceleration (or driving force) by half, and under the economy mode, the accelerator stroke is further restricted to further limit the maximum acceleration (or driving force).

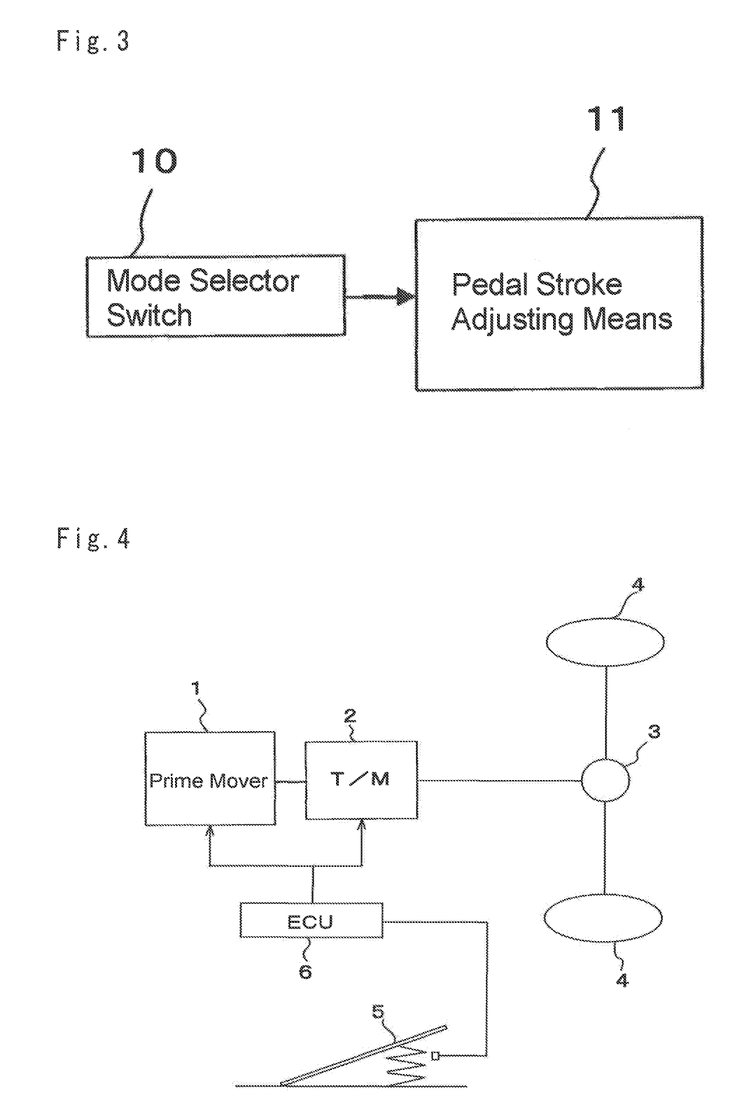

For example, those driving modes may be selected by operating a switch. For this purpose, as shown in FIG. 3, a mode selector switch 10 is arranged at a position possible to be operated by the driver. The mode selector switch 10 is adapted to send a signal to a pedal stroke adjusting means 11 to control a stroke of the accelerator pedal 5. In case the power mode is selected by operating the mode selector switch 10, the stroke of the accelerator pedal 5 will not be restricted. In this case, therefore, the maximum accelerator stroke “Psmax” in the above-explained formula for calculating the acceleration demand Gx is assigned a value of the maximum structural depth of the accelerator pedal 5, and the maximum acceleration “Gxmax” is assigned a value of the maximum acceleration achieved at the maximum depth of the accelerator pedal 5. As described, in case the normal mode is selected by operating the mode selector switch 10, the accelerator stroke is restricted to nearly half depth. In this case, therefore, the maximum accelerator stroke “Psmax” in the above-explained formula for calculating the acceleration demand Gx is assigned a value about half of the maximum structural depth of the accelerator pedal 5, and the maximum acceleration “Gxmax” is assigned a value of the acceleration achieved at about an intermediate depth of the accelerator pedal 5, in case the economy mode is selected by operating the mode selector switch 10, the stroke of the accelerator pedal 5 is further restricted to improve the fuel economy. In this case, therefore, the maximum accelerator stroke “Psmax” in the above-explained formula for calculating the acceleration demand Gx is assigned a value smaller than that under the normal mode, and the maximum acceleration “Gxmax” is assigned a value of the acceleration achieved at the maximum accelerator stroke under the economy mode. Therefore, each characteristic curve of calculation value of the acceleration demand extends from the common base point at which a minimum acceleration expressed as “Gx0” is generated by a creep torque during idling, and those curves individually have a similarity shape. Consequently, the maximum accelerator stroke “Psmax” and the maximum acceleration “Gxmax” are reduced sequentially in the order of the power mode, the normal mode and the economy mode.

Thus, according to the control system of the present invention, the maximum accelerator stroke “Psmax” and the maximum acceleration “Gxmax” can be changed by shifting the driving mode. Therefore, the characteristic curve of calculation value of the acceleration demand can be altered to suit the driver's taste in the acceleration feeling depending on the selected driving mode. Especially, according to the example of the control system explained with reference to FIGS. 2 and 3, the characteristic curves of calculation value of the acceleration demand for those driving modes are substantially identical or similar to one another in the range where the accelerator stroke is smaller than the maximum stroke. Therefore, the driver will not feel any uncomfortable feeling resulting from a difference in an operating feeling of the accelerator pedal 5 or the like.

In conclusion, the control system of the present invention is configured to calculate a target acceleration (or a target driving force) by the foregoing procedures, and the electronic control unit 6 sends command signals to the prime mover 1, the transmission 2 etc. to control the output torque and the speed ratio in a manner to achieve the target acceleration or the target driving force.

In the foregoing example, the accelerator stroke is employed as the operating amount to calculate the acceleration demand as a control amount. It is to be understood, however, that the control system of the present invention may be modified to employ another kinds of operating amount as a parameter such as a steering angle to control a yaw rate and so on.

1. A vehicle control system, which is configured to calculate a control amount with respect to an operating amount of a driver, and to control a vehicle based on the calculated control amount, comprising:
a calculation means that calculates the control amount by exponentiating the operating amount in a manner to increase a climb gradient of the control amount in accordance with an increase in the operating amount in a first range where the operating amount is small, and to decrease the climb gradient of the control amount in accordance with an increase in the operating amount in a second range where the operating amount is large; and
wherein the calculation means is configured to exponentiate the control amount using a power index, which is determined in a manner to keep a difference between the calculated control amount and a control amount determined for a reference vehicle whose maximum control amount is different within a predetermined range, from a minimum operating amount to a maximum operating amount.

2. The vehicle control system as claimed in claim 1, wherein the power index is determined based on a maximum operating amount with respect to a vehicle speed.

3. The vehicle control system as claimed in claim 1,
wherein the calculation means is configured to calculate the control amount by multiplying the exponentiated operating amount by a coefficient; and
the coefficient is determined based on a maximum operating amount and a maximum control amount.

4. The vehicle control system as claimed in claim 1,
wherein the vehicle comprises a mode selector means that selects a driving mode from a plurality of driving modes; and
the power index is determined for each driving mode.

5. The vehicle control system as claimed in claim 4,
wherein the vehicle further comprises an operating amount adjusting means that alters a maximum structural operating amount in accordance with the power index for the driving mode selected by the mode selector means.

6. The vehicle control system as claimed in claim 1,
wherein the vehicle comprises a prime mover an output thereof is changed by operating an accelerator;
the operating amount includes an accelerator stroke; and
the control amount includes a target acceleration or a target driving force.

7. The vehicle control system as claimed in claim 6,
wherein the calculation means is configured to calculate the target acceleration or the target driving force using the flowing formulas:
Gx=c·Ps^{k}+Gx0; and
c=(Gxmax−Gx0)/Psmax^{k};
where Gx is the target acceleration or the target driving force, c is the coefficient, Ps is an opening degree of the accelerator, Psmax is the maximum opening degree of the accelerator, Gx0 is a minimum acceleration or a minimum driving force of the vehicle, Gxmax is a maximum acceleration or a maximum driving force of the vehicle, and k is the power index.

8. A manufacturing method of a vehicle control system that calculates a target acceleration or a target driving force, and controls a vehicle in a manner to achieve the calculated target acceleration or target driving force, comprising:
determining a coefficient c and a power index k in the following formulas for a given reference vehicle;
determining the coefficient c and the power index k for another vehicle whose maximum acceleration or maximum driving force is different from that of the reference vehicle, in a manner to approximate a relation between the target acceleration or the target driving force of said another vehicle and the opening degree of the accelerator, within a predetermined range around a relation between the target acceleration or the target driving force of the reference vehicle and the opening degree of the accelerator; and
thereafter calculating the target acceleration or the target driving force for said another vehicle by assigning the determined coefficient c and the power index k into the following formulas:
Gx=c·Ps^{k}+Gx0; and
c=(Gxmax−Gx0)/Psmax^{k};
where Gx is the target acceleration or the target driving force, c is the coefficient, Ps is an opening degree of the accelerator, Psmax is the maximum opening degree of the accelerator, Gx0 is a minimum acceleration or a minimum driving force of the vehicle, Gxmax is a maximum acceleration or a maximum driving force of the vehicle, and k is the power index.
